(19) United States
(12) Patent Application Publication
(10) Pub. No.: US 2014/0258762 A1
(43) Pub. Date: Sep. 11, 2014

(54) SERVER AND POWER MANAGEMENT METHOD

(71) Applicant: HON HAI PRECISION INDUSTRY CO., LTD., New Taipei (TW)

(72) Inventors: LI-WEN CHANG, New Taipei (TW); CHIH-CHUNG SHIH, New Taipei (TW)

(73) Assignee: HON HAI PRECISION INDUSTRY CO., LTD., New Taipei (TW)

(21) Appl. No.: 13/955,297

(22) Filed: Jul. 31, 2013

(30) Foreign Application Priority Data
Mar. 5, 2013 (TW) 102107609

(51) Int. Cl. G06F 1/30; G06F 1/26

(52) U.S. Cl. CPC G06F 1/30; G06F 1/263
USPC 713/340

(57) ABSTRACT

A server and a power management method for the server are provided. The server is connected to other servers. The server includes a power source and a battery. The battery and batteries of other servers are in parallel. The server monitors power supplying of the server in real time. When the power source does not provide enough power for the server, the server sends a trigger signal to control the battery and the batteries of other servers to provide power for the server.

### BACKGROUND

1. Technical Field

The disclosure relates to a server and a power management method adapted for the server.

2. Description of Related Art

When a power source does not provide enough power for a server, a battery often provides back up power for the server, but since the capacity of the battery is limited, an energy in the battery quickly exhausts, therefore, the server only works for a short while.

Therefore, what is needed is a server to overcome the described shortcoming.

### BRIEF DESCRIPTION OF THE DRAWINGS

FIG. 1 is a block diagram of a server in accordance with an exemplary embodiment.

FIG. 2 is a schematic view of a flow direction of an electrical current of a battery of the server of FIG. 1 when the battery discharges.

FIG. 3 is a running environment view of the server of FIG. 1.

FIG. 4 is a flowchart of managing power method adapted for the server of FIG. 1.

### DETAILED DESCRIPTION

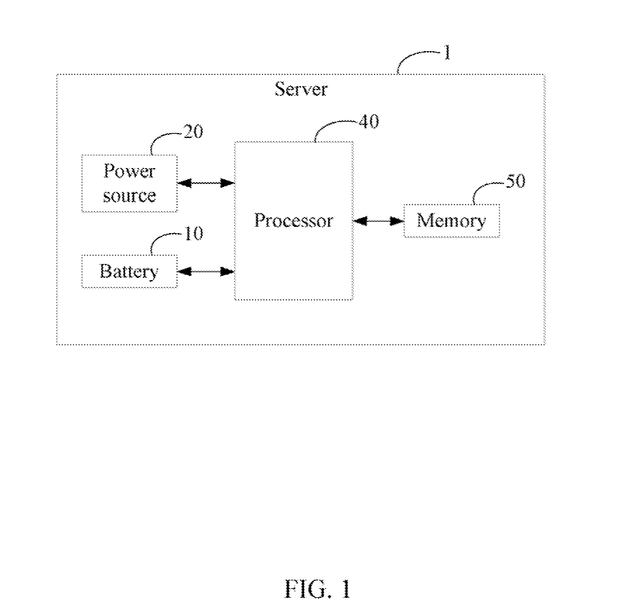

FIG. 1 is a block diagram of a server in accordance with an exemplary embodiment. The server 1 includes a battery 10, a power source 20, a processor 40, and a memory 50. The power source 20 provides a working voltage of 220v for the server 1. The battery 10 provides power for the server 1 if an abnormal condition on the power source 20 occurs. For example, when the power source 20 does not provide enough power for the server 1, such as a power failure, bad power quantity, the battery 10 provides power for the server 1. The processor 40 controls the server 1 to work. The memory 50 stores a preset voltage and other data, such as preset running environment data of the server 1.

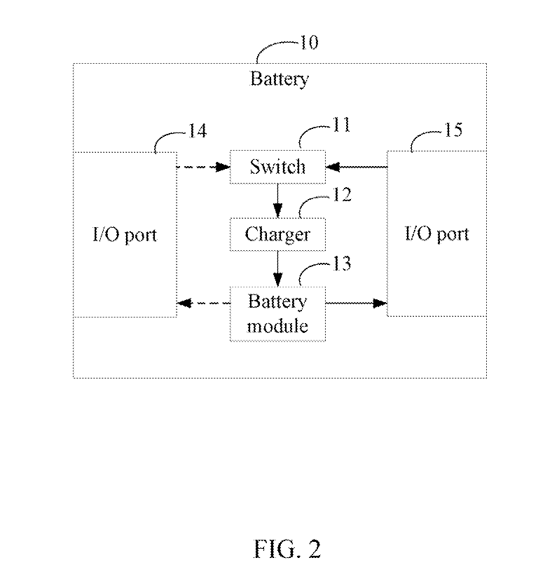

As shown in FIG. 2, the battery 10 includes a switch 11, a charger 12, a battery module 13, and two input-output (I/O) ports 14, 15. One of the two input-output ports 14, 15 is connected to one of the batteries of other servers, and the other I/O port is connected to the processor 40.

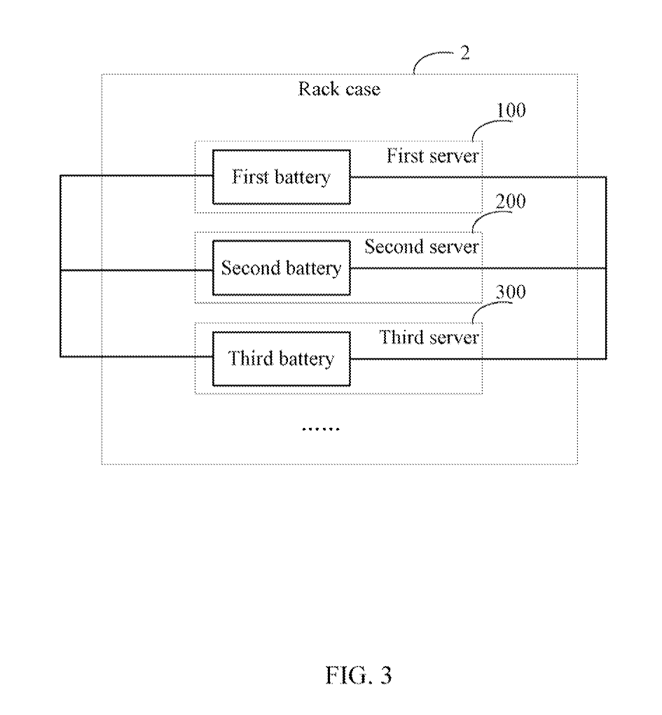

The server 1 is connected to other servers. The battery 10 of the server 1 and the batteries of other servers are in parallel. As shown in FIG. 3, a rack case 2 is incased in a number of servers 100, 200, 300 which are connected to each other and the three batteries, such as a first battery, a second battery, and a third battery, are in parallel, thereby establishing a parallel connection between all batteries.

FIG. 2 shows that the battery 10 includes two discharge paths. For the sake of simplicity, only one the battery 10 from the disclosure is described, the I/O port 14, which is connected to the battery of other server, is defined as an external one; and the I/O port 15, which is connected to the processor 40, is defined as an inner one. One of the two discharge paths is for the server 1 itself and the other is for other servers. A first path is described as below. The processer 40 controls the electrical current of the battery 10 to flow into the switch 11 in response to the trigger signal via the I/O port 15, the switch 11 controls the charger 12 to discharge for the battery module 13, and the current flows out the I/O port 15 and provides power for the server 1 after the battery modules 13 complete discharge. Therefore, the current of the battery 10 can flow to the processor 40 via the I/O port 15.

A second path is described as below. The processer 40 controls the current of the battery 10 to flow into the switch 11 in response to the trigger signal via the I/O port 14, the switch 11 controls the charger 12 to discharge for the battery module 13, and the current flows out the I/O port 14 and provides power for the other servers after the battery modules 13 complete discharge. Therefore, when the I/O port 14 is connected to a battery of another server, the current of the battery 10 of the server 1 can flow to the batteries of other servers via the I/O port 14.

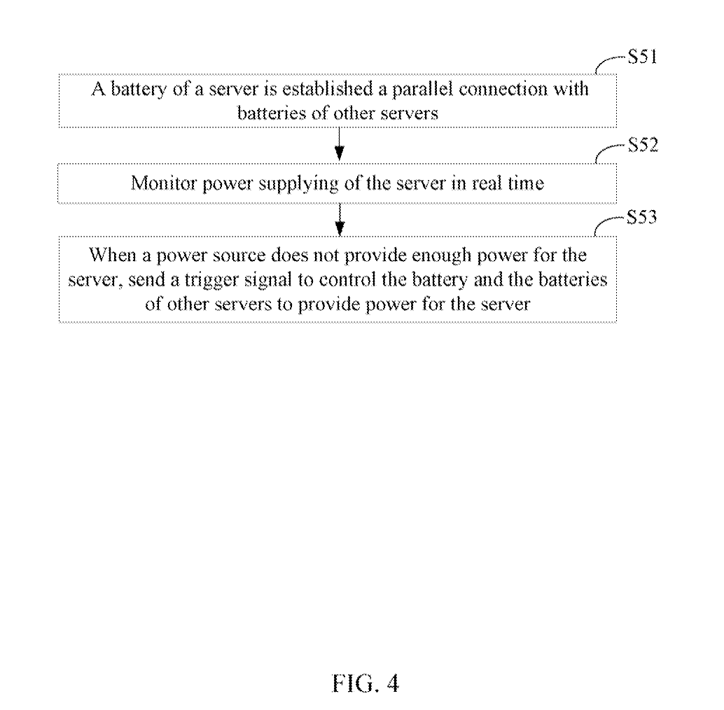

FIG. 4 is a flowchart of managing power method adapted for the server of FIG. 1.

In step S51, the battery 10 of the server 1 is established a parallel connection with the batteries of other servers.

In step S52, the processor 40 monitors power supplying of the server 1 in real time.

In step S53, when the power source 20 does not provide enough power for the server 1, for example, the work voltage of the server 1 is less than the preset voltage in the memory 50, or the power source 20 does not provide stable power, the processor 40 sends a trigger signal to control the battery 10 and the batteries of other servers to provide power for the server 1.

The server 1 is connected to other servers and the battery 10 of the servers and the batteries of other servers are in parallel. Therefore, when the power source 20 does not provide enough power for the server 1, the server 1 controls the battery 10 and the batteries of other servers to provide power for the server 1, leading that an intelligent use of all batteries of all servers and the server 1 can work a maximum time.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A server comprising:
a power source;
a battery which is connected to batteries of other servers in parallel; and
a processor to monitor power supplying of the server in real time, and when the power source does not provide enough power for the server, send a trigger signal to control the battery and the batteries of other servers to provide power for the server.

2. The server as recited in claim 1, wherein the battery comprises a switch, a charger, a battery module, and two input-output ports, one of the two input-output ports is connected to one of the batteries of other servers, and the other is connected to the processor.

3. The server as recited in claim 2, wherein the processor is configured to control current of the battery to flow to the switch in response to the trigger signal, the switch controls the charger to discharge for the battery module, and the current flows to the one of the two input-output ports and provides power for the server after the battery module completes discharge.

4. A power management method adapted for a server, wherein the server comprises a power source and a battery which is connected to batteries of other servers in parallel, the method comprising:
monitoring power supplying of the server in real time; and
when the power source does not provide enough power for the server, sending a trigger signal to control the battery and the batteries of other servers to provide power for the server.

5. The power management method as recited in claim 4, wherein the battery comprises a switch, a charger, a battery module, and two input-output ports, one of the two input-output ports is connected to one of the batteries of other servers, and the other is connected to the server.

6. The power management method as recited in claim 5, the step “sending a trigger signal to control the battery to provide power for the server” comprising:
controlling current of the battery to flow to the switch in response to the trigger signal;
the switch controlling the charger to discharge for the battery module; and
the current flowing to the one of the two input-output ports and providing power for the server after the battery module completes discharge.
